(19) United States
(12) Patent Application Publication
(10) Pub. No.: US 2026/0162240 A1
(43) Pub. Date: Jun. 11, 2026

(54) STRUCTURE DETECTION METHOD AND SYSTEM FOR LOW-LIGHT CONFINED SPACE BASED ON MOBILE-FIXED COLLABORATIVE GUIDANCE

(71) Applicant: Tongji University, Shanghai (CN)

(72) Inventors: Gang Li, Shanghai (CN); Jiayi Hu, Shanghai (CN); Bin He, Shanghai (CN); Runjie Shen, Shanghai (CN)

(21) Appl. No.: 19/026,563

(22) Filed: Jan. 17, 2025

(30) Foreign Application Priority Data
Dec. 5, 2024 (CN) 202411781768.7

(51) Int. Cl. G06T 7/00; G05D 1/246; G05D 1/622; G05D 1/646; G05D 101/15; G05D 105/80; G05D 107/50; G05D 109/20; G05D 111/10; G05D 111/67; G06V 10/82; G06V 20/17

(52) U.S. Cl. CPC G06T 7/0004; G05D 1/246; G05D 1/622; G05D 1/646; G06V 10/82; G06V 20/17; G05D 2101/15; G05D 2105/89; G05D 2107/50; G05D 2109/20; G05D 2111/10; G05D 2111/67; G06T 2207/10032; G06T 2207/20081; G06T 2207/20084

(57) ABSTRACT

A structure detection method and system for a low-light confined space based on mobile-fixed collaborative guidance are provided. The method is implemented by a fixed sensor node network and an unmanned aerial vehicle detection system in a mobile-fixed collaborative system. The method includes: the fixed sensor node network collecting image data of the low-light confined space, generating a basic disease data map, transmitting the basic disease data map to the unmanned aerial vehicle detection system, performing global path planning through a dual-mode adaptive confined space disease detection path planning algorithm to generate a precise detection path and a supplementary detection path; and the unmanned aerial vehicle detection system detecting diseases in the low-light confined space according to the precise detection path and the supplementary detection path through a machine learning algorithm, and obtaining a disease map result.

### CROSS REFERENCE TO RELATED APPLICATIONS

The present disclosure claims the priority to the Chinese patent application with the application No. 2024117817687, entitled “STRUCTURE DETECTION METHOD AND SYSTEM FOR LOW-LIGHT CONFINED SPACE BASED ON MOBILE-FIXED COLLABORATIVE GUIDANCE” and filed on Dec. 5, 2024 with the Chinese Patent Office, the contents of which are incorporated in the present disclosure by reference in their entirety.

### TECHNICAL FIELD

The present disclosure relates to the technical field of structure disease detection for confined spaces, and in particular to a structure detection method and system for a low-light confined space based on mobile-fixed collaborative guidance.

### BACKGROUND ART

With the acceleration of urbanization, the development and utilization of confined space structures, including tunnels and tower barrels, are becoming more and more extensive. However, confined space structures are in a high-pressure and humid environment for a long time, which is prone to cracks and leakage structure diseases, threatening structural safety. Traditional manual inspection methods are inefficient and difficult to detect potential risks in a timely manner. Therefore, it is of great significance to develop an efficient and accurate disease detection method for confined structure spaces.

In the prior art, the fixed sensor network and mobile detection equipment are two kinds of commonly used detection methods. The fixed sensor network can perform long-time monitoring, but have limited coverage range and are difficult to achieve comprehensive detection. The mobile detection equipment such as unmanned aerial vehicle (UAV) is highly flexible, but has limited detection effect in low-light poor texture underground space environments, affecting the detection results. The above two detection methods often operate independently and lack an effective collaborative mechanism.

### SUMMARY

In order to solve the technical problems in the prior art that the coverage range is limited, comprehensive detection cannot be performed, detection effect is limited in low-light poor texture underground space environments, affecting detection results, and the fixed sensor network and mobile detection equipment lack a collaborative mechanism, embodiments of the present disclosure provide a structure detection method and system for a low-light confined space based on mobile-fixed collaborative guidance. The technical solution is as follows.

In an aspect, a structure detection method for a low-light confined space based on mobile-fixed collaborative guidance is provided, and the method is implemented by a structure detection device for a low-light confined space based on mobile-fixed collaborative guidance, and the method includes:
S1. a fixed sensor node network collecting image data of the low-light confined space and generating a basic disease data map;
S2, a fixed sensor node network transmitting the basic disease data map to an unmanned aerial vehicle (UAV) detection system, and performing global path planning through a dual-mode adaptive confined space disease detection path planning algorithm, to generate a precise detection path and a supplementary detection path; and
S3. the UAV detection system detecting the diseases in the low-light confined space according to the precise detection path and the supplementary detection path through a U-Net deep learning algorithm to obtain a disease map result of the structure of the low-light confined space.

Optionally, the disease map result of the structure of the low-light confined space includes: results of diseases not covered by fixed sensors and results of diseases covered by the fixed sensors.

In the above, the results of diseases include: disease location, disease type and disease severity.

Optionally, the performing global path planning through a dual-mode adaptive confined space disease detection path planning algorithm to generate a precise detection path and a supplementary detection path in S2 includes:
S21. acquiring a basic disease data map and a three-dimensional map model of the confined space;
S22. dividing the confined space into a plurality of sections according to the basic disease data map and the three-dimensional map model of the confined space, and determining characteristics of each section according to fixed sensor distribution and known disease distribution;
S23. determining a task type for each section according to the characteristics of each section;
S24. performing detection planning on each section according to the task type of each section, to obtain a precise detection plan and a supplementary detection plan;
S25. generating a precise detection path and a supplementary detection path according to the precise detection plan and the supplementary detection plan; and
S26. optimizing the precise detection path by using an obstacle avoidance algorithm to obtain an optimized precise detection path, and optimizing the supplementary detection path by using the obstacle avoidance algorithm to obtain an optimized supplementary detection path.

Optionally, after the step of the UAV detection system detecting the diseases in the low-light confined space according to the precise detection path and the supplementary detection path through a machine learning algorithm to obtain a disease map result of the structure of the low-light confined space in S3, it further includes:
a mobile-fixed collaborative system adopting an information decentralization method to send a notification message to a specified fixed sensor node, and the specified fixed sensor node receiving the notification message and shortening the perception period of the mobile-fixed collaborative system by adjusting the perception period of the fixed sensor, to obtain a new perception period of the mobile-fixed collaborative system.

Optionally, the mobile-fixed collaborative system adopting an information decentralization method to send a notification message to a specified fixed sensor node and the specified fixed sensor node receiving the notification message and shortening the perception period of the mobile-fixed collaborative system by adjusting the perception period of the fixed sensor to obtain a new perception period of the mobile-fixed collaborative system includes:
the mobile-fixed collaborative system determining the impact range of each detected disease according to the disease map result of the structure of the low-light confined space detected by the UVA detection system;
determining a notified fixed sensor set according to the impact range of each detected disease;
constructing a communication function according to the notified fixed sensor set, and constructing a perception period adjustment function according to the communication function;
performing perception period adjustment on each fixed sensor according to the perception period adjustment function, and outputting the adjusted perception period of the each fixed sensor; and
shortening the perception period of the mobile-fixed collaborative system according to the adjusted perception period of each fixed sensor, to obtain the new perception period of the mobile-fixed collaborative system.

Optionally, the mobile-fixed collaborative system updates a fixed sensor node network deployment plan according to the results of diseases not covered by the fixed sensors to obtain a new fixed sensor node network deployment plan, the updating including:
constructing a fixed sensor deployment utility function according to the results of diseases not covered by fixed sensors;
defining a fixed sensor coverage function, and constructing an optimization problem based on the fixed sensor coverage function; and
solving the optimization problem by using a Monte Carlo tree search algorithm, to obtain the new fixed sensor node network deployment plan.

Optionally, after the step of obtaining a new fixed sensor node network deployment plan, it further includes:
constructing a deployment decision function, and evaluating the new fixed sensor node network deployment plan according to the deployment decision function to obtain an evaluation result; and
determining, according to the evaluation result, whether to execute the new fixed sensor node network deployment plan, where if the evaluation result is 1, the new fixed sensor node network deployment plan is executed to update a fixed sensor network topology, and if the evaluation result is 0, an original fixed sensor node network deployment plan is kept.

In another aspect, a structure detection system for a low-light confined space based on mobile-fixed collaborative guidance is provided, and the system is applied to the structure detection method for a low-light confined space based on mobile-fixed collaborative guidance, and the system includes:
a fixed sensor node network, used to collect image data of the low-light confined space, generate a basic disease data map, and transmit the basic disease data map to a UAV detection system; and
the UAV detection system, used to perform global path planning through a dual-mode adaptive confined space disease detection path planning algorithm to generate a precise detection path and a supplementary detection path, and detecting diseases in the low-light confined space according to the precise detection path and the supplementary detection path through a U-Net deep learning algorithm to obtain the disease map result of the structure of the low-light confined space.

Optionally, the disease map result of the structure of the low-light confined space includes: results of diseases not covered by fixed sensors and results of diseases covered by fixed sensors.

In the above, the results of diseases include: disease location, disease type and disease severity.

Optionally, the performing global path planning through a dual-mode adaptive confined space disease detection path planning algorithm to generate a precise detection path and a supplementary detection path includes:
acquiring a basic disease data map and a three-dimensional map model of the confined space;
dividing the confined space into a plurality of sections according to the basic disease data map and the three-dimensional map model of the confined space, and determining characteristics of each section according to fixed sensor distribution and known disease distribution;
determining a task type for each section according to the characteristics of each section;
performing detection planning on each section according to the task type of each section, to obtain a precise detection plan and a supplementary detection plan;
generating a precise detection path and a supplementary detection path according to the precise detection plan and the supplementary detection plan; and
optimizing the precise detection path by using an obstacle avoidance algorithm to obtain an optimized precise detection path, and optimizing the supplementary detection path by using the obstacle avoidance algorithm to obtain an optimized supplementary detection path.

Optionally, after the step of the UAV detection system detecting the diseases in the low-light confined space according to the precise detection path and the supplementary detection path through a machine learning algorithm to obtain a disease map result of the structure of the low-light confined space in S3, it further includes:
a mobile-fixed collaborative system adopting an information decentralization method to send a notification message to a specified fixed sensor node, and the specified fixed sensor node receiving the notification message and shortening the perception period of the mobile-fixed collaborative system by adjusting the perception period of the fixed sensor, to obtain a new perception period of the mobile-fixed collaborative system.

Optionally, the mobile-fixed collaborative system adopting an information decentralization method to send a notification message to a specified fixed sensor node and the specified fixed sensor node receiving the notification message and shortening the perception period of the mobile-fixed collaborative system by adjusting the perception period of the fixed sensor to obtain a new perception period of the mobile-fixed collaborative system includes:
the mobile-fixed collaborative system determining the impact range of each detected disease according to the disease map result of the structure of the low-light confined space detected by the UVA detection system;
determining a notified fixed sensor set according to the impact range of each detected disease;
constructing a communication function according to the notified fixed sensor set, and constructing a perception period adjustment function according to the communication function;
performing perception period adjustment on each fixed sensor according to the perception period adjustment function, and outputting the adjusted perception period of the each fixed sensor; and
shortening the perception period of the mobile-fixed collaborative system according to the adjusted perception period of each fixed sensor, to obtain a new perception period of the mobile-fixed collaborative system.

Optionally, the mobile-fixed collaborative system updates a fixed sensor node network deployment plan according to the results of diseases not covered by the fixed sensors to obtain a new fixed sensor node network deployment plan, the updating including:
constructing a fixed sensor deployment utility function according to the results of diseases not covered by fixed sensors;
defining a fixed sensor coverage function, and constructing an optimization problem based on the fixed sensor coverage function; and
solving the optimization problem by using a Monte Carlo tree search algorithm, to obtain a new fixed sensor node network deployment plan.

Optionally, after the step of obtaining a new fixed sensor node network deployment plan, it further includes:
constructing a deployment decision function, and evaluating the new fixed sensor node network deployment plan according to the deployment decision function to obtain an evaluation result; and
determining, according to the evaluation result, whether to execute the new fixed sensor node network deployment plan, where if the evaluation result is 1, the new fixed sensor node network deployment plan is executed to update a fixed sensor network topology, and if the evaluation result is 0, an original fixed sensor node network deployment plan is kept.

In another aspect, a structure detection device for a low-light confined space based on mobile-fixed collaborative guidance is provided, and the structure detection device for a low-light confined space based on mobile-fixed collaborative guidance includes: a processor; and a memory, on which computer-readable instructions are stored, where when the computer-readable instructions are executed by the processor, any one of the structure detection methods for a low-light confined space based on mobile-fixed collaborative guidance above is implemented.

In another aspect, a computer-readable storage medium is provided, in which at least one instruction is stored. The at least one instruction is loaded and executed by a processor to implement any one of the structure detection methods for a low-light confined space based on mobile-fixed collaborative guidance above.

The beneficial effects brought about by the technical solutions provided by the embodiments of the present disclosure include at least the follows.

In the embodiments of the present disclosure, firstly, the image data of a low-light confined space is collected through a fixed sensor node network to generate a basic disease data map; secondly, the fixed sensor node network transmits the basic disease data map to the UAV detection system, guides the UAV to perform the detection task, and performs global path planning through a dual-mode adaptive confined space disease detection path planning algorithm to generate a precise detection path and a supplementary detection path; and finally, the UAV detection system detects diseases in the low-light confined space according to the precise detection path and the supplementary detection path through a machine learning algorithm to obtain a disease map result of the structure of the low-light confined space. The embodiments of the present disclosure detect the diseases in the low-light confined space through the collaborative work of the UAV detection system and the fixed sensor node network, thereby improving the efficiency and accuracy of structure disease detection.

### BRIEF DESCRIPTION OF DRAWINGS

In order to more clearly illustrate the technical solutions in the embodiments of the present disclosure, the following briefly introduces the drawings required for use in the description of the embodiments. Apparently, the drawings described below are only some embodiments of the present disclosure. For those skilled in the art, other drawings may be obtained based on these drawings without paying creative efforts.

FIG. 1 is an overall flow chart of a structure detection method for a low-light confined space based on mobile-fixed collaborative guidance;

FIG. 2 is a flow chart of a structure detection method for a low-light confined space based on mobile-fixed collaborative guidance provided by embodiments of the present disclosure;

FIG. 3 is a flow chart of a dual-mode adaptive confined space disease detection path planning algorithm provided by embodiments of the present disclosure;

FIG. 4 is a schematic view of path planning visualization of a dual-mode adaptive confined space disease detection path planning algorithm provided by embodiments of the present disclosure;

FIG. 5 is a schematic structural view of a UAV multifunctional detection system provided by embodiments of the present disclosure;

FIG. 6 is a block diagram of a structure detection system for a low-light confined space based on mobile-fixed collaborative guidance provided by embodiments of the present disclosure; and

FIG. 7 is a schematic structural view of a structure detection device for a low-light confined space based on mobile-fixed collaborative guidance provided by embodiments of the present disclosure.

### DETAILED DESCRIPTION OF EMBODIMENTS

The technical solutions of the present disclosure are described below in conjunction with the drawings.

In the embodiments of the present disclosure, words such as “exemplarily” and “for example” are used to indicate examples, illustrations or explanations. Any embodiment or design described as “example” in the present disclosure should not be interpreted as being more preferred or more advantageous than other embodiments or designs. Exactly, the use of the word “example” is intended to present the concept in a specific way. In addition, in the embodiments of the present disclosure, the meaning expressed by “and/or” may be refer to that there are both, or there may be either of the two.

In the embodiments of the present disclosure, “image” and “picture” may sometimes be used interchangeably. It should be noted that when the difference between them is not emphasized, the meanings they intend to express are the same. “of”, “relevant” and “corresponding” may sometimes be used interchangeably. It should be noted that when the difference between them is not emphasized, the meanings they intend to express are the same.

In the embodiments of the present disclosure, sometimes a subscript such as W1 may be written in a non-subscript form, such as W1. When the difference is not emphasized, the meanings they intend to express are the same.

In order to make the technical problems, technical solutions and advantages to be solved by the present disclosure clearer, a detailed description will be given below with reference to the drawings and specific embodiments.

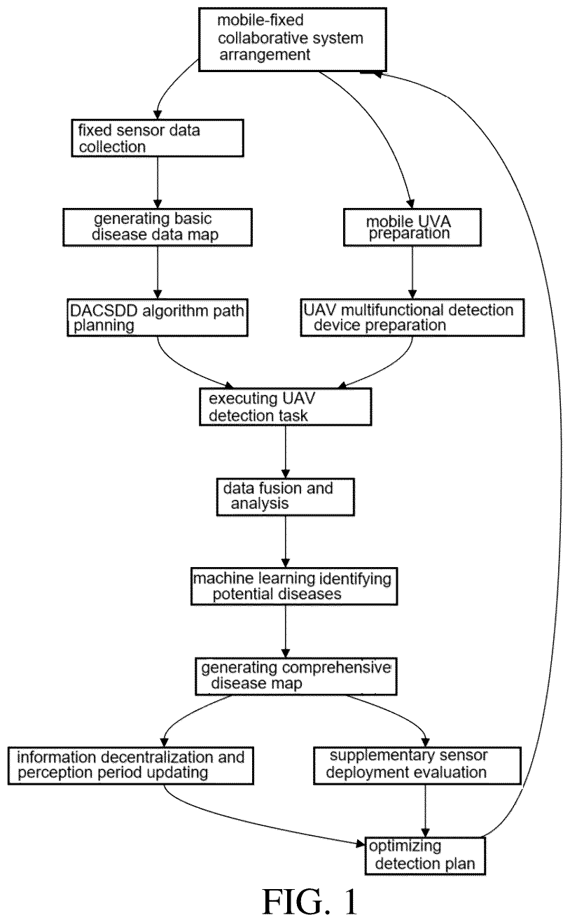

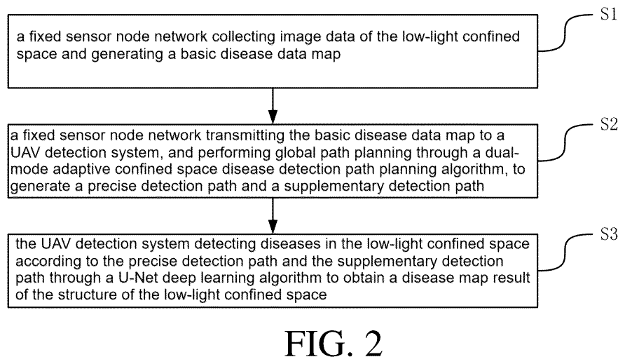

Embodiments of the present disclosure provide a structure detection method for a low-light confined space based on mobile-fixed collaborative guidance, which may be implemented by a structure detection device for a low-light confined space based on mobile-fixed collaborative guidance. The structure detection device for a low-light confined space based on mobile-fixed collaborative guidance may be a terminal or a server. As shown in FIG. 1, an overall flow chart of a structure detection method for a low-light confined space based on mobile-fixed collaborative guidance is provided; and as shown in the flow chart of a structure detection method for a low-light confined space based on mobile-fixed collaborative guidance in FIG. 2, the processing flow of the method may include the following steps:
S1. a fixed sensor node network collecting image data of the low-light confined space and generating a basic disease data map.

In the above, the low-light confined space includes a tunnel, an aqueduct, or a tower barrel.

In the above, the fixed sensor node network includes a plurality of fixed sensor nodes.
S2. the fixed sensor node network transmitting the basic disease data map to the UAV detection system, and performing global path planning through a dual-mode adaptive confined space disease detection path planning algorithm to generate a precise detection path and a supplementary detection path.

In the above, DACSDD algorithm is a dual-mode adaptive confined space disease detection path planning algorithm.

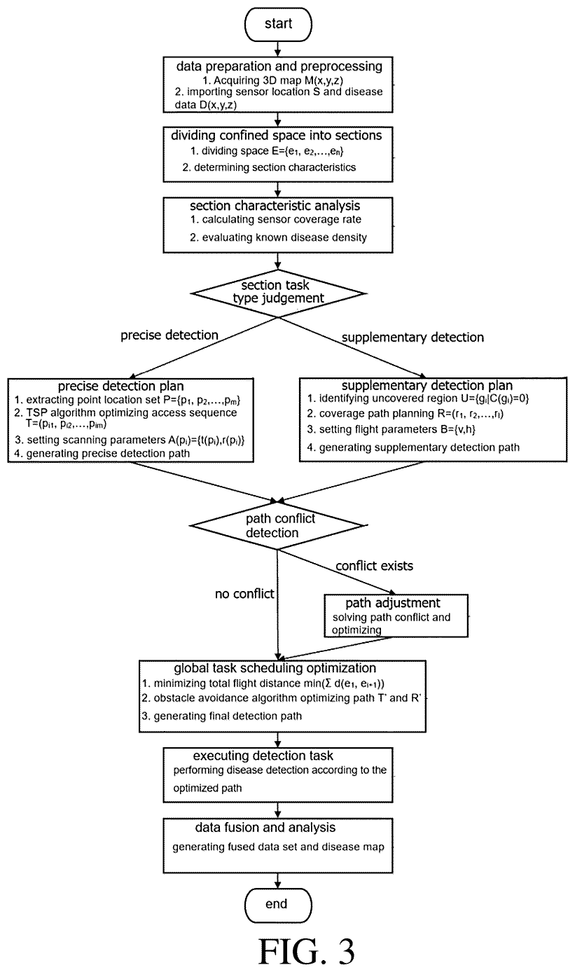

In the above, as shown in FIG. 3, it is a flow chart of the dual-mode adaptive confined space disease detection path planning algorithm. In a feasible implementation, the sensor location and disease data are acquired; the sensor location and disease data are imported into the three-dimensional map model of the confined space; the confined space is divided into sections and the section characteristics are determined; the sensor coverage rate is calculated and the known disease density is evaluated; the section task type is determined according to the sensor coverage rate and the known disease density, where the section task types include: precise detection and supplementary detection; the implementation process of the precise detection plan includes: extracting a point location set, optimizing the access sequence by using the TSP algorithm, setting scanning parameters, and generating a precise detection path according to the scanning parameters; the implementation process of the supplementary detection plan includes: identifying an uncovered region, acquiring a coverage path plan according to the uncovered region, and setting flight parameters; generating the supplementary detection path according to the flight parameters; determining whether there is path conflict detection, according to the precise detection path and the supplementary detection path; performing path adjustment if there is a conflict, to resolve the path conflict and perform optimization, and performing task scheduling optimization after resolving the path conflict and optimizing the path; performing global task scheduling optimization if there is no path conflict, calculating the minimized total flight distance, optimizing the precise detection path and the supplementary detection path by using the obstacle avoidance algorithm, to obtain the optimized precise detection path and the optimized supplementary detection path; and performing the detection task according to the optimized precise detection path and the optimized supplementary detection path, to generate a fused data set and a disease map result.

Optionally, the specific implementation process of S2 may include S21-S26:
S21. acquiring a basic disease data map and a three-dimensional map model of the confined space.

In a feasible implementation, a location set of fixed sensor nodes is acquired; the location set of the fixed sensor nodes is imported into a three-dimensional map model of a confined space; and a basic disease data map is acquired, and the confined space is divided into networks according to the basic disease data map.

In the above, the basic disease data map includes the location information of each known disease point, the disease type, the degree of damage and other information.
S22. dividing the confined space into a plurality of sections according to the basic disease data map and the three-dimensional map model of the confined space, and determining characteristics of each section according to fixed sensor distribution and known disease distribution.
S23, determining a task type for each section according to the characteristics of each section.

In the above, the task types include: precise detection and supplementary detection, the basis for confirming the task type includes but is not limited to: sensor coverage rate, known disease density and section importance.
S24. performing detection planning on each section according to the task type of each section, to obtain a precise detection plan and a supplementary detection plan.

In the above, the precise detection plan is for sections to be precisely detected. In a feasible implementation, the specific steps of executing the precise detection plan to generate the precise detection path include:
(1) extracting, from the basic disease data map, a point location set that requires precise detection;
(2) optimizing, according to the point location set, access sequence of point locations in the point location set by using the TSP algorithm, to obtain the optimized path, where the TSP algorithm may be solved by a genetic algorithm.
(3) setting scanning parameters for each detection point according to the optimized path to generate the precise detection path, where the scanning parameters include: hovering time and scanning accuracy.

In the above, the supplementary detection plan is for sections to be supplementarily detected; and the specific steps of executing the supplementary detection plan to generate the supplementary detection path includes:
(1) identifying regions that are not covered by the fixed sensor network;
(2) generating a region covering path according to the uncovered region by using an improved Boustrophedon algorithm; and
(3) setting flight parameters according to the region covering path, and generating a supplementary detection path, where the flight parameters include: flight speed and flight altitude.
S25. generating a precise detection path and a supplementary detection path according to the precise detection plan and the supplementary detection plan.
S26. optimizing the precise detection path by using an obstacle avoidance algorithm to obtain an optimized precise detection path, and optimizing the supplementary detection path by using the obstacle avoidance algorithm to obtain an optimized supplementary detection path.

In the above, the obstacle avoidance algorithm may adopt methods such as A*, RRT and D* Lite. The present disclosure adopts the A* method to optimize the conversion path between sections to minimize the total flight distance. The process of minimizing the total flight distance may be expressed by the following formula (1):

$$d = min ( \sum d ( {e}_{i} , {e}_{i + 1} ) ) \qquad ( 1 )$$

In the above, d(eᵢ, eᵢ₊₁) represents the distance from the section eᵢ to section eᵢ₊₁; d represents the total flight distance; and E={e₁, e₂, . . . , eₙ} represents the sections obtained by dividing the confined space.
S3. the UAV detection system detecting the diseases in the low-light confined space according to the precise detection path and the supplementary detection path through a U-Net deep learning algorithm to obtain a disease map result of the structure of the low-light confined space.

In a feasible implementation, a fused data set is obtained by fusing the data collected by the UAV detection system and the data collected by the fixed sensors. Based on the fused data set, the process of using the machine learning algorithm for analysis may be expressed by the following formula (2):

$$ML ( F ) = {p}_{1} , {p}_{2} , … , {p}_{k} \qquad ( 2 )$$

In the above, pᵢ represents the i-th identified disease; F={f₁, f₂, . . . , fₙ}. represents the fused data set; fₙ represents the n-th data sample; and MLO represents the U-Net deep learning algorithm.

In the above, according to the disease map result of the structure of the low-light confined space, the detection result is visualized to generate a heat map of the health status of the low-light confined space, which can be expressed by the following formula (3):

$$H ( x , y , z ) = g ( R ) \qquad ( 3 )$$

In the above, H(x, y, z)g represents the heat value of the health status; g. represents a heat map generation function; R={l₁, l₂, . . . , lₘ} represents the disease map result of the structure of the low-light confined space lᵢ; (x, y, z, t, s) where x,y,z represent disease location; t represents disease type; and s represents disease severity.

Optionally, the disease map result of the structure of the low-light confined space includes: results of diseases not covered by the fixed sensors and results of diseases covered by the fixed sensors.

In the above, the results of diseases include: disease location, disease type and disease severity.

Optionally, after the step of the UAV detection system detecting the diseases in the low-light confined space according to the precise detection path and the supplementary detection path through a U-Net deep learning algorithm to obtain a disease map result of the structure of the low-light confined space in S3, it further includes:
a mobile-fixed collaborative system adopting an information decentralization method to send a notification message to a specified fixed sensor node, and the specified fixed sensor node receiving the notification message and shortening the perception period of the mobile-fixed collaborative system by adjusting the perception period of the fixed sensor, to obtain a new perception period of the mobile-fixed collaborative system.

In the above, the information decentralization method refers to a method of decentralizing decision-making power and management power from a higher level of management layer to a lower level of management layer or place in the fields of administrative management, corporate management, etc., which method is mastered by a skilled person in the art and will not be further elaborated in this application.

Optionally, the mobile-fixed collaborative system adopting an information decentralization method to send a notification message to a specified fixed sensor node and the specified fixed sensor node receiving the notification message and shortening the perception period of the mobile-fixed collaborative system by adjusting the perception period of the fixed sensor to obtain a new perception period of the mobile-fixed collaborative system includes:
the mobile-fixed collaborative system determining the impact range of each detected disease according to the disease map result of the structure of the low-light confined space detected by the UVA detection system.

In a feasible implementation, the impact range of each detected disease may be expressed by the following formula (4):

$$R ( {h}_{i} ) = \{ ( x , y , z ) \vert d ( ( x , y , z ) , {h}_{i} ) \leq r \} \qquad ( 4 )$$

In the above, hᵢ represents each detected disease; d represents the distance function, and r represents the predetermined threshold.
determining the notified fixed sensor set according to the impact range of each detected disease; and
constructing a communication function according to the notified fixed sensor set, and constructing a perception period adjustment function according to the communication function.

In the above, the communication function may be expressed by the following formula (5):

$$C ( h , S ) : H \times P ( S ) \to M \qquad ( 5 )$$

In the above, S represents the fixed sensor set, S=s₁, s₂, . . . , sₙ, where sᵢ represents the coordinates of the location of the i-th sensor; P(S) represents the power set of the fixed sensor set, M represents the message space; and H={h₁, h₂, . . . , hₘ} represents the disease set.

In the above, the perception period adjustment function may be expressed by the following formula (6):

$$A ( m , T ) : M \times {+}^{} \to {+}^{} \qquad ( 6 )$$

In the above, T represents the original perception period; m represents the generated notification message; and [symbol] ⁺ represents a set of positive real numbers.
performing perception period adjustment on each fixed sensor according to the perception period adjustment function, and outputting the adjusted perception period of the each fixed sensor;

In a feasible implementation, the generated notification message is transmitted to each sensor; and the perception period adjustment function is used to perform perception period adjustment on each fixed sensor to obtain an updated perception period, which may be expressed by the following formula (7):

$${T}_{new} = A ( m , {T}_{old} ) \qquad ( 7 )$$

in the above, T_{new} represents the updated perception period of each fixed sensor; and T_{old}. represents the original perception period of each fixed sensor.
shortening the perception period of the mobile-fixed collaborative system according to the adjusted perception period of each fixed sensor, to obtain a new perception period of the mobile-fixed collaborative system.

In a feasible implementation, by shortening the perception period of the mobile-fixed collaborative system, the perception probability of the mobile-fixed collaborative system can be improved. In the above, according to the new perception period of the mobile-fixed collaborative system, the improvement of system performance may be evaluated by using the following formula (8):

$$Δ P = {P ( S , H )}_{new} - {P ( S , H )}_{old} \qquad ( 8 )$$

In the above, P(S,H)new represents the system performance value after adopting the new perception period; P(S,H)old represents the system performance value when using the original perception period; and ΔP represents the improvement amount of system performance.

Optionally, the mobile-fixed collaborative system updates a fixed sensor node network deployment plan according to the results of diseases not covered by the fixed sensors to obtain a new fixed sensor node network deployment plan, the updating including:
constructing a fixed sensor deployment utility function according to the results of diseases not covered by fixed sensors;

In a feasible implementation, the fixed sensor deployment utility function may be expressed by the following formula (9):

$$E ( s , U ) : S \times P ( U ) \to \qquad ( 9 )$$

In the above, U={u₁, u₂, . . . , uₙ} represents the result of diseases not covered by the fixed sensors, uᵢ=(x,y,z,t,s,p) represents the i-th uncovered disease and contains multiple attributes, x,y,z represents disease location; t represents the type; s represents the severity; p represents the detection probability; and [symbol] represents a real number set.

In the above, the fixed sensor deployment utility function is used to evaluate the utility of deploying sensors at location s for detecting diseases in U.
defining a fixed sensor coverage function, and constructing an optimization problem according to the fixed sensor coverage function.

In the above, the sensor coverage function may be expressed by the following formula (10):

$$C ( s ) : S \to P ( {ℝ}^{3} ) \qquad ( 10 )$$

In the above, c(s). represents the coverage range of the sensor s; P( [symbol] ³) represents the power set of the three-dimensional real space; and S represents the sensor set.

In the above, the optimization problem may be expressed by the following formula (11):

$$max \sum E ( {s}_{i} , U ) , \\ s . t . \vert {s}_{i} \vert \leq N ⋃ C ( {s}_{i} ) ⊇ ( x , y , z ) \vert ∃ u ∈ U , \\ u = ( x , y , z , t , s , p ) ∧ p > {p}_{threshold} \qquad ( 11 )$$

In the above, p_{threshold} represents the detection probability threshold; p represents the detection probability; and N represents the maximum number of sensors allowed to be deployed.
solving the optimization problem by using a Monte Carlo tree search algorithm, to obtain a new fixed sensor node network deployment plan.

In the above, the Monte Carlo tree search algorithm is a conventional technical means and will not be further elaborated in this application.

Optionally, after obtaining a new fixed sensor node network deployment plan, it further includes:
constructing a deployment decision function, and evaluating the new fixed sensor node network deployment plan according to the deployment decision function to obtain an evaluation result.

In a feasible implementation, the deployment decision function may be expressed by the following formula (12):

$$DCost ( {S}_{new} ) : P ( S ) \times \times \to \{ 0 , 1 \} \qquad ( 12 )$$

In the above, Cost(S_{new}) represents the cost function of the new fixed sensor node network deployment plan.
determining, according to the evaluation result, whether to execute the new fixed sensor node network deployment plan, where if the evaluation result is 1, the new fixed sensor node network deployment plan is executed to update a fixed sensor network topology, and if the evaluation result is 0, an original fixed sensor node network deployment plan is kept.

In a feasible implementation, whether to execute the new fixed sensor node network deployment plan is determined according to the evaluation result. When Cost(S_{new})=1, the new fixed sensor node network deployment plan is executed and the fixed sensor network topology is updated; and when Cost (S_{new})=0, the original fixed sensor node network deployment plan is kept, where the process of updating the fixed sensor network topology may be expressed by the following formula (13):

$$T ( S ) : P ( S ) \to G \qquad ( 13 )$$

In the above, G represents a graph structure, which is used to represent the connection relationship between sensors.

In the above, according to the new fixed sensor node network deployment plan, the overall perception probability of the system is re-evaluated by the following formula (14):

$$P ( S ⋃ {S}_{new} , H ) \qquad ( 14 )$$

In the above, S_{new}=s₁, s₂ . . . , sₖ represents the new fixed sensor node network deployment plan.

In a feasible implementation, the mobile-fixed collaborative system is called fixed-mobile network convergence, which means that through the integration and cooperation between fixed networks and mobile networks, full-service and convergence service operations are achieved, providing users with diverse and high-quality communication, information, entertainment and other services.

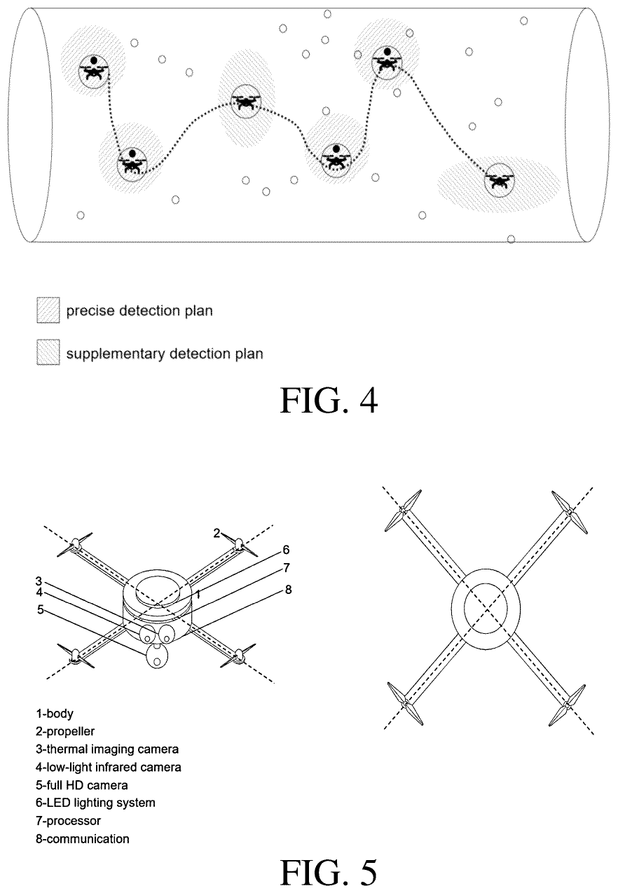

As shown in FIG. 4, it is a schematic view of path planning visualization of a dual-mode adaptive confined space disease detection path planning algorithm provided by embodiments of the present disclosure, where the mobile-fixed collaborative system in the present application includes: a fixed sensor node network and a UAV detection system, where the fixed sensor node network includes: a leak water sensor, a dip angle sensor and a seam sensor. As shown in FIG. 5, it is a schematic structural view of a UAV multifunctional detection system provided by embodiments of the present disclosure. The UAV detection system includes: a UAV body, a propulsion system, a processor, a memory, a communication system and a general sensor system.

In the above, a remotely adjustable LED lighting system may be provided on the UAV body. The rotatable head installed on the UAV body contains multiple LED light sources. The rotatable head may rotate 360 degrees to provide all-round lighting.

In the above, for different illumination environments, the processor is used to intelligently adjust the system brightness to adapt to different environments, where the intelligent brightness adjustment includes: optimal lighting angle and optimal lighting intensity, where the intelligent brightness adjustment optimization problem may be expressed by the following formulas (15)-(17):

$$min f ( θ , I ) = {w}_{1} * {E}_{shadow} ( θ , I ) + {w}_{2} * {E}_{glare} ( θ , I ) \qquad ( 15 )$$

$$- {w}_{3} * {E}_{detail} ( θ , I ) \qquad ( 16 )$$

$$s . t . {θ}_{min} \leq θ \leq {θ}_{max} , {I}_{min} \leq I \leq {I}_{max} \qquad ( 17 )$$

In the above, E_{shadow}(θ,I) represents the area of the shadow region; E_{glare}(θ,I) represents the degree of glare; E_{detail}(θ,I) represents the richness of image details; w₁ represents the first weight coefficient; w₂ represents the second weight coefficient; w₃ represents the third weight coefficient; θₘᵢₙ represents the minimum allowable lighting angle; θₘₐₓ represents the maximum allowable lighting angle; Iₘᵢₙ represents the minimum allowable lighting intensity; Iₘₐₓ represents the maximum allowable lighting intensity; θ represents the lighting angle; and I represents the lighting intensity.

In the above, the processor is used to calculate and control the remote adjustment LED lighting system, including:
(1) calculating the optimal lighting angle and optimal lighting intensity based on environmental data;
(2) controlling the rotatable head to rotate to the optimal lighting angle; and
(3) controlling the output light intensity of the LED light source to the optimal lighting intensity.

In the above, the processor is further used to perform fusion processing and disease detection on multi-source data collected by the general sensor system, including:
(1) extracting image features by using a ResNet50 architecture-based deep convolutional neural network, according to the image data collected by the full HD camera;
(2) extracting temperature anomaly features according to the heat map data collected by a thermal imaging camera;
(3) extracting infrared features according to infrared image data collected by a low-light infrared camera;
(4) fusing the image features, temperature anomaly features, and infrared features to obtain fused features; and
(5) classifying the fused features by using a ResNet50 architecture-based deep convolutional neural network pre-trained on a large-scale structure disease dataset, and identifying the types and locations of structure diseases in the confined space.

In a feasible implementation, the UAV detection system may be equipped with a multi-sensor combined perception system, including: a full HD camera, a thermal imaging camera and a low-light infrared camera, where the full HD camera is used to capture clear structural surface images; the thermal imaging camera is used to detect temperature anomalies and identify potential leakage or structural problems; and the low-light infrared camera is used to use infrared information to expand image information in low-light environments.

In the embodiments of the present disclosure, firstly, the image data of a low-light confined space is collected through a fixed sensor node network to generate a basic disease data map; secondly, the fixed sensor node network transmits the basic disease data map to the UAV detection system, guides the UAV to perform the detection task, and performs global path planning through a dual-mode adaptive confined space disease detection path planning algorithm to generate a precise detection path and a supplementary detection path; and finally, the UAV detection system detects diseases in the low-light confined space according to the precise detection path and the supplementary detection path through a machine learning algorithm to obtain a disease map result of the structure of the low-light confined space. The embodiments of the present disclosure detect the diseases in the low-light confined space through the collaborative work of the UAV detection system and the fixed sensor node network, thereby improving the efficiency and accuracy of structure disease detection.

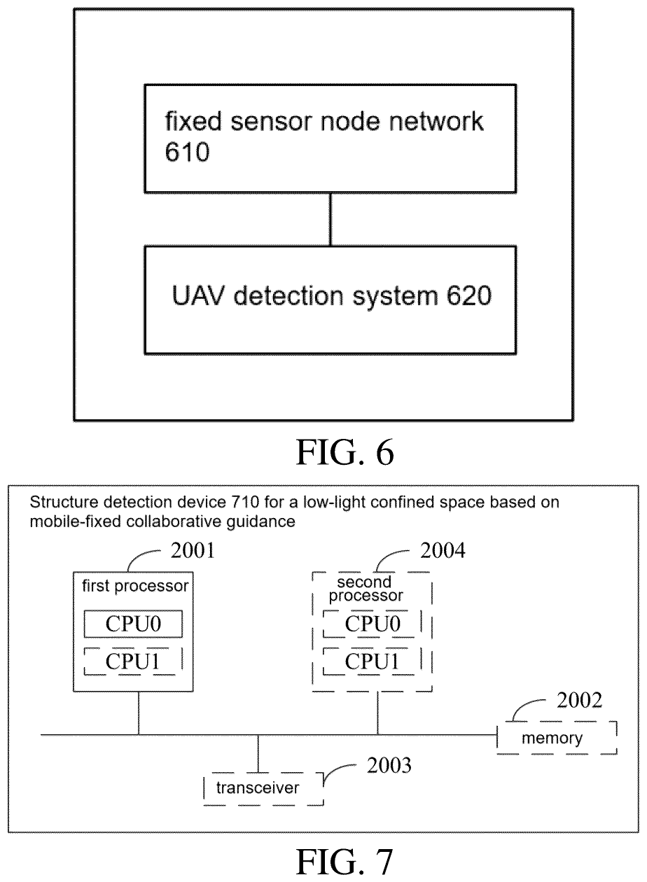

FIG. 6 is block diagram of a structure detection system for a low-light confined space based on mobile-fixed collaborative guidance according to an exemplary embodiment, the system being used in a structure detection method for a low-light confined space based on mobile-fixed collaborative guidance. Referring to FIG. 6, the system includes a fixed sensor node network 610 and a UAV detection system 620.

In the above, the fixed sensor node network 610 is used to collect image data of the low-light confined space and generate a basic disease data map, and transmit the basic disease data map to the UAV detection system; and the UAV detection system 620 is used to perform global path planning through a dual-mode adaptive confined space disease detection path planning algorithm to generate a precise detection path and a supplementary detection path, and detecting diseases in the low-light confined space according to the precise detection path and the supplementary detection path through a U-Net deep learning algorithm to obtain a disease map result of the structure of the low-light confined space.

Optionally, the disease map result of the structure of the low-light confined space includes: results of diseases not covered by fixed sensors and results of diseases covered by fixed sensors.

In the above, the results of diseases include: disease location, disease type and disease severity.

Optionally, the performing global path planning through a dual-mode adaptive confined space disease detection path planning algorithm to generate a precise detection path and a supplementary detection path includes:
acquiring a basic disease data map and a three-dimensional map model of the confined space;
dividing the confined space into a plurality of sections according to the basic disease data map and the three-dimensional map model of the confined space, and determining characteristics of each section according to fixed sensor distribution and known disease distribution;
determining a task type for each section according to the characteristics of each section;
performing detection planning on each section according to the task type of each section, to obtain a precise detection plan and a supplementary detection plan;
generating a precise detection path and a supplementary detection path according to the precise detection plan and the supplementary detection plan; and
optimizing the precise detection path by using an obstacle avoidance algorithm to obtain an optimized precise detection path, and optimizing the supplementary detection path by using the obstacle avoidance algorithm to obtain an optimized supplementary detection path.

Optionally, after the step of the UAV detection system detecting the diseases in the low-light confined space according to the precise detection path and the supplementary detection path through a machine learning algorithm to obtain a disease map result of the structure of the low-light confined space, it further includes:
a mobile-fixed collaborative system adopting an information decentralization method to send a notification message to a specified fixed sensor node, and the specified fixed sensor node receiving the notification message and shortening the perception period of the mobile-fixed collaborative system by adjusting the perception period of the fixed sensor, to obtain a new perception period of the mobile-fixed collaborative system.

Optionally, the mobile-fixed collaborative system adopting an information decentralization method to send a notification message to a specified fixed sensor node and the specified fixed sensor node receiving the notification message and shortening the perception period of the mobile-fixed collaborative system by adjusting the perception period of the fixed sensor to obtain a new perception period of the mobile-fixed collaborative system includes:
the mobile-fixed collaborative system determining the impact range of each detected disease according to the disease map result of the structure of the low-light confined space detected by the UVA detection system;
determining a notified fixed sensor set according to the impact range of each detected disease;
constructing a communication function according to the notified fixed sensor set, and constructing a perception period adjustment function according to the communication function;
performing perception period adjustment on each fixed sensor according to the perception period adjustment function, and outputting the adjusted perception period of the each fixed sensor; and
shortening the perception period of the mobile-fixed collaborative system according to the adjusted perception period of each fixed sensor, to obtain a new perception period of the mobile-fixed collaborative system.

Optionally, the mobile-fixed collaborative system updates a fixed sensor node network deployment plan according to the results of diseases not covered by the fixed sensors to obtain a new fixed sensor node network deployment plan, the updating including:
constructing a fixed sensor deployment utility function according to the results of diseases not covered by fixed sensors;
defining a fixed sensor coverage function, and constructing an optimization problem according to the fixed sensor coverage function; and
solving the optimization problem by using a Monte Carlo tree search algorithm, to obtain the new fixed sensor node network deployment plan.

Optionally, after the step of obtaining the new fixed sensor node network deployment plan, it further includes:
constructing a deployment decision function, and evaluating the new fixed sensor node network deployment plan according to the deployment decision function to obtain an evaluation result; and
determining, according to the evaluation result, whether to execute the new fixed sensor node network deployment plan, where if the evaluation result is 1, the new fixed sensor node network deployment plan is executed to update a fixed sensor network topology, and if the evaluation result is 0, an original fixed sensor node network deployment plan is kept.

In the embodiments of the present disclosure, firstly, the image data of a low-light confined space is collected through a fixed sensor node network to generate a basic disease data map; secondly, the fixed sensor node network transmits the basic disease data map to the UAV detection system, guides the UAV to perform the detection task, and performs global path planning through a dual-mode adaptive confined space disease detection path planning algorithm to generate a precise detection path and a supplementary detection path; and finally, the UAV detection system detects diseases in the low-light confined space according to the precise detection path and the supplementary detection path through a machine learning algorithm to obtain a disease map result of the structure of the low-light confined space. The embodiments of the present disclosure detect the diseases in the low-light confined space through the collaborative work of the UAV detection system and the fixed sensor node network, thereby improving the efficiency and accuracy of structure disease detection.

FIG. 7 is a schematic structural view of a structure detection device for a low-light confined space based on mobile-fixed collaborative guidance provided by embodiments of the present disclosure. As shown in FIG. 7, the structure detection device for a low-light confined space based on mobile-fixed collaborative guidance may include the structure detection system for a low-light confined space based on mobile-fixed collaborative guidance shown in FIG. 6. Optionally, the structure detection device 710 for a low-light confined space based on mobile-fixed collaborative guidance may include a first processor 2001.

Optionally, the structure detection device 710 for a low-light confined space based on mobile-fixed collaborative guidance may further include a memory 2002 and a transceiver 2003.

In the above, the first processor 2001, the memory 2002 and the transceiver 2003 may be connected via a communication bus.

Detailed introductions will be made to the various components of the structure detection device 710 for a low-light confined space based on mobile-fixed collaborative guidance in conjunction with FIG. 6.

In the above, the first processor 2001 is the control center of the structure detection device 710 for a low-light confined space based on mobile-fixed collaborative guidance, which may be a processor or a general term for multiple processing elements. For example, the first processor 2001 may refer to one or more central processing units (CPUs), may be an application specific integrated circuit (ASIC), or may be one or more integrated circuits configured to implement the embodiments of the present disclosure, such as one or more microprocessors (digital signal processors, DSPs), or one or more field programmable gate arrays (FPGAs).

Optionally, the first processor 2001 may execute various functions of the structure detection device 710 for a low-light confined space based on mobile-fixed collaborative guidance by running or executing a software program stored in the memory 2002 and calling data stored in the memory 2002.

In a specific implementation, as an example, the first processor 2001 may include one or more CPUs, for example, CPU0 and CPU1 shown in FIG. 7.

In a specific implementation, as an embodiment, the structure detection device 710 for a low-light confined space based on mobile-fixed collaborative guidance may also include multiple processors, for example, the first processor 2001 and the second processor 2004 shown in FIG. 7. Each of these processors may be a single-core processor (single-CPU) or a multi-core processor (multi-CPU). The processor here may refer to one or more devices, circuits, and/or processing cores for processing data (for example, computer program instructions).

In the above, the memory 2002 is used to store the software program for executing the solution of the present disclosure which is controlled to be executed by the first processor 2001. The specific implementation may refer to the above method embodiments, which will not be repeated here.

Optionally, the memory 2002 may be a read-only memory (ROM) or other type of static storage device that can store static information and instructions, a random access memory (RAM) or other type of dynamic storage device that can store information and instructions, or may be an electrically erasable programmable read-only memory (EEPROM), a compact disc read-only memory (CD-ROM) or other optical disc storage, optical disc storage (including compressed optical disc, laser disc, optical disc, digital versatile disc, Blu-ray disc, etc.), a magnetic disk storage medium or other magnetic storage device, or any other medium that can be used to carry or store desired program codes in the form of instructions or data structures and can be accessed by a computer, but is not limited thereto. The memory 2002 may be integrated with the first processor 2001, or may exist independently, and be coupled to the first processor 2001 through the interface circuit (not shown in FIG. 7) of the structure detection device 710 for a low-light confined space based on mobile-fixed collaborative guidance, which is not specifically limited in the embodiment of the present disclosure.

The transceiver 2003 is used to communicate with a network device or a terminal device.

Optionally, the transceiver 2003 may include a receiver and a transmitter (not shown separately in FIG. 7), where the receiver is used to implement a receiving function, and the transmitter is used to implement a sending function.

Optionally, the transceiver 2003 may be integrated with the first processor 2001, or may exist independently and be coupled to the first processor 2001 through an interface circuit (not shown in FIG. 7) of the structure detection device 710 for a low-light confined space based on mobile-fixed collaborative guidance, which is not specifically limited in the embodiment of the present disclosure.

It should be indicated that the structure of the structure detection device 710 for a low-light confined space based on mobile-fixed collaborative guidance shown in FIG. 7 does not constitute a limitation on the router, and the actual knowledge structure recognition device may include more or fewer components than those shown in the drawings, a combination of some components, or different arrangement of components.

In addition, the technical effects of the structure detection device 710 for a low-light confined space based on mobile-fixed collaborative guidance can refer to the technical effects of the structure detection method for a low-light confined space based on mobile-fixed collaborative guidance described in the above method embodiments, which will not be repeated here.

It should be understood that the first processor 2001 in the embodiments of the present disclosure may be a central processing unit (CPU), and the processor may also be other general-purpose processor, digital signal processor (DSP), application specific integrated circuit (ASIC), field programmable gate array (FPGA) or other programmable logic device, discrete gate or transistor logic device, discrete hardware component, etc. The general-purpose processor may be a microprocessor or the processor may also be any conventional processor, etc.

It should also be understood that the memory in the embodiments of the present disclosure may be a volatile memory or a non-volatile memory, or may include both volatile and non-volatile memories. Among them, the non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of exemplary, not limiting description, many forms of random access memory (RAM) are available, such as static RAM (SRAM), dynamic random access memory (DRAM), synchronous DRAM (SDRAM), double data rate SDRAM (DDR SDRAM), enhanced SDRAM (ESDRAM), synchlink DRAM (SLDRAM), and direct rambus RAM (DR RAM).

The above embodiments may be all or partially implemented by software, hardware (such as circuit), firmware or any other combination. When implemented by using software, the above embodiments may be all or partially implemented in the form of a computer program product. The computer program product includes one or more computer instructions or computer programs. When the computer instructions or computer programs are loaded or executed on a computer, processes or functions described according to the embodiments of the present disclosure are all or partially generated. The computer may be a general-purpose computer, a special-purpose computer, a computer network, or other programmable system. The computer instructions may be stored in a computer-readable storage medium, or transmitted from one computer-readable storage medium to another computer-readable storage medium. For example, the computer instructions may be transmitted from one website, computer, server or data center to another website, computer, server or data center by wired (such as infrared, wireless, microwave, etc.) manner. The computer-readable storage medium may be any available medium that can be accessed by a computer or a data storage device such as a server or data center that contains one or more available media sets. The available medium may be a magnetic medium (for example, a floppy disk, a hard disk, a tape), an optical medium (for example, a DVD), or a semiconductor medium. The semiconductor medium may be a solid-state hard disk.

It should be understood that the term “and/or” herein is only used to describe the association relationship of associated objects, indicating that there may be three relationships. For example, A and/or B may indicate three situations: A exists alone, A and B both exist, and B exists alone, where A and B may be singular or plural. In addition, the character “/” herein generally indicates that the associated objects therebefore and thereafter are in an “or” relationship, but it may also indicate an “and/or” relationship, which may refer to the context for specific understanding.

In the present disclosure, “at least one” means one or more, and “plurality/multiple” means two or more. “At least one of the following (items)” or similar expression refers to any combination of these items, including any combination of single or plural items. For example, at least one of a, b, or c may mean: a, b, c, a-b, a-c, b-c, or a-b-c, where a, b, and c may be singular or plural.

It should be understood that in various embodiments of the present disclosure, the serial numbers of the above-mentioned processes do not mean the execution order. The execution order of the individual processes should be determined by its function and internal logic, and should not constitute any limitation on the implementation process of the embodiments of the present disclosure.

Those skilled in the art will appreciate that the units and algorithm steps of each example described in conjunction with the embodiments disclosed herein may be implemented in electronic hardware, or a combination of computer software and electronic hardware. Whether these functions are performed in hardware or software depends on the specific application and design constraint conditions of the technical solution. Professional and technical personnel may use different methods to implement the described functions for each specific application, but such implementation should not be considered to be beyond the scope of the present disclosure.

Those skilled in the art can clearly understand that for the convenient and brief description, the specific working processes of the above-described equipment, systems and units may refer to the corresponding processes in the aforementioned method embodiments and will not be repeated here.

In the several embodiments provided by the present disclosure, it should be understood that the disclosed devices, systems and methods may be implemented in other ways. For example, the system embodiments described above are only schematic. For example, the division of the units is only a logical function division. There may be other division methods in actual implementation. For example, multiple units or components may be combined or integrated into another device, or some features may be ignored or not executed. Another point is that the mutual coupling or direct coupling or communication shown or discussed may be indirect coupling or communication through some interfaces, systems or units, which may be electrical, mechanical or in other forms.

The units described as separate components may or may not be physically separated, and the components displayed as units may or may not be physical units, that is, they may be located in one place or distributed on multiple network units. Some or all of the units may be selected according to actual needs to achieve the purpose of the solutions of the embodiments.

In addition, the individual functional units in individual embodiments of the present disclosure may be integrated into one processing unit, or the individual units may exist physically separately, or two or more units may be integrated into one unit.

If the functions are implemented in the form of software functional units and sold or used as independent products, they may be stored in a computer-readable storage medium. Based on this understanding, the technical solution of the present disclosure, or the part that contributes to the prior art or a part of the technical solution may be embodied in the form of a software product. The computer software product is stored in a storage medium, including several instructions for enabling a computer device (which may be a personal computer, server, or network device, etc.) to execute all or part of the steps of the methods described in various embodiments of the present disclosure. The aforementioned storage medium includes: U disk, mobile hard disk, read-only memory (ROM), random access memory (RAM), disk or optical disk, and other media that may store program codes.

The above are only specific embodiments of the present disclosure, but the protection scope of the present disclosure is not limited thereto. Any person skilled in the art who is familiar with the art may easily think of changes or substitutions within the technical scope disclosed by the present disclosure, which should be included in the protection scope of the present disclosure. Therefore, the protection scope of the present disclosure shall be subjected to the protection scope of the claims.

1. A structure detection method for a low-light confined space based on mobile-fixed collaborative guidance, the structure detection method for a low-light confined space based on mobile-fixed collaborative guidance being implemented by a fixed sensor node network and an unmanned aerial vehicle (UAV) detection system in a mobile-fixed collaborative system, and the method comprising:
S1, the fixed sensor node network collecting image data of the low-light confined space and generating a basic disease data map;
S2, the fixed sensor node network transmitting the basic disease data map to the UAV detection system, and performing global path planning through a dual-mode adaptive confined space disease detection path planning algorithm to generate a precise detection path and a supplementary detection path; and
S3, the UAV detection system detecting diseases in the low-light confined space according to the precise detection path and the supplementary detection path through a U-Net deep learning algorithm to obtain a disease map result of a structure of the low-light confined space.

2. The structure detection method for a low-light confined space based on mobile-fixed collaborative guidance according to claim 1, wherein the disease map result of the structure of the low-light confined space comprises: results of diseases not covered by fixed sensors and results of diseases covered by fixed sensors,
wherein the results of diseases comprise: a disease location, a disease type and a disease severity.

3. The structure detection method for a low-light confined space based on mobile-fixed collaborative guidance according to claim 1, wherein the performing global path planning through a dual-mode adaptive confined space disease detection path planning algorithm to generate a precise detection path and a supplementary detection path in the S2 comprises:
S21, acquiring a basic disease data map and a three-dimensional map model of the confined space;
S22, dividing the confined space into a plurality of sections according to the basic disease data map and the three-dimensional map model of the confined space, and determining characteristics of each of the sections according to fixed sensor distribution and known disease distribution;
S23, determining a task type for the each section according to the characteristics of the each section;
S24, performing detection planning on the each section according to the task type of the each section, to obtain a precise detection plan and a supplementary detection plan;
S25, generating a precise detection path and a supplementary detection path according to the precise detection plan and the supplementary detection plan; and
S26, optimizing the precise detection path by using an obstacle avoidance algorithm to obtain an optimized precise detection path, and optimizing the supplementary detection path by using the obstacle avoidance algorithm to obtain an optimized supplementary detection path.

4. The structure detection method for a low-light confined space based on mobile-fixed collaborative guidance according to claim 1, after the UAV detection system detecting the diseases in the low-light confined space according to the precise detection path and the supplementary detection path through the U-Net deep learning algorithm to obtain the disease map result of the structure of the low-light confined space in the S3, further comprising:
the mobile-fixed collaborative system adopting an information decentralization method to send a notification message to a specified fixed sensor node, and the specified fixed sensor node receiving the notification message and shortening a perception period of the mobile-fixed collaborative system by adjusting a perception period of the fixed sensor, to obtain a new perception period of the mobile-fixed collaborative system.

5. The structure detection method for a low-light confined space based on mobile-fixed collaborative guidance according to claim 4, wherein the mobile-fixed collaborative system adopting the information decentralization method to send the notification message to the specified fixed sensor node and the specified fixed sensor node receiving the notification message and shortening the perception period of the mobile-fixed collaborative system by adjusting the perception period of the fixed sensor to obtain the new perception period of the mobile-fixed collaborative system comprises:
the mobile-fixed collaborative system determining an impact range of each of detected diseases according to the disease map result of the structure of the low-light confined space detected by the UAV detection system;
determining a notified fixed sensor set according to the impact range of the each detected disease;
constructing a communication function according to the notified fixed sensor set, and constructing a perception period adjustment function according to the communication function;
performing perception period adjustment on each of the fixed sensors according to the perception period adjustment function, and outputting the adjusted perception period of the each fixed sensor; and
shortening the perception period of the mobile-fixed collaborative system according to the adjusted perception period of the each fixed sensor, to obtain the new perception period of the mobile-fixed collaborative system.

6. The structure detection method for a low-light confined space based on mobile-fixed collaborative guidance according to claim 1, wherein the mobile-fixed collaborative system updates a fixed sensor node network deployment plan according to the results of diseases not covered by the fixed sensors to obtain a new fixed sensor node network deployment plan, the updating comprising:
constructing a fixed sensor deployment utility function according to the results of diseases not covered by the fixed sensors;
defining a fixed sensor coverage function, and constructing an optimization problem based on the fixed sensor coverage function; and
solving the optimization problem by using a Monte Carlo tree search algorithm to obtain the new fixed sensor node network deployment scheme.

7. The structure detection method for a low-light confined space based on mobile-fixed collaborative guidance according to claim 6, after the obtaining the new fixed sensor node network deployment plan, further comprising:
constructing a deployment decision function, and evaluating the new fixed sensor node network deployment plan according to the deployment decision function to obtain an evaluation result; and
determining, according to the evaluation result, whether to execute the new fixed sensor node network deployment plan based on the evaluation result, wherein if the evaluation result is 1, the new fixed sensor node network deployment plan is executed to update a fixed sensor network topology, and if the evaluation result is 0, an original fixed sensor node network deployment plan is kept.

8. A structure detection system for a low-light confined space based on mobile-fixed collaborative guidance, configured to implement the structure detection method for a low-light confined space based on mobile-fixed collaborative guidance according to claim 1, wherein the system comprises:
a fixed sensor node network, configured to collect image data of the low-light confined space, generate a basic disease data map, and transmit the basic disease data map to a UAV detection system; and
the UAV detection system, configured to perform global path planning through a dual-mode adaptive confined space disease detection path planning algorithm to generate a precise detection path and a supplementary detection path, and detecting diseases in the low-light confined space according to the precise detection path and the supplementary detection path through a U-Net deep learning algorithm to obtain a disease map result of a structure of the low-light confined space.

9. A structure detection device for a low-light confined space based on mobile-fixed collaborative guidance, comprising:
a processor; and
a memory having computer-readable instructions stored thereon, wherein when the computer-readable instructions are executed by the processor, the method according to claim 1 is implemented.

10. A computer-readable storage medium, wherein program codes are stored in the computer-readable storage medium, and the program codes can be called by a processor to execute the method according to claim 1.

11. The structure detection system for a low-light confined space based on mobile-fixed collaborative guidance according to claim 8, wherein the disease map result of the structure of the low-light confined space comprises: results of diseases not covered by fixed sensors and results of diseases covered by fixed sensors,
wherein the results of diseases comprise: a disease location, a disease type and a disease severity.

12. The structure detection system for a low-light confined space based on mobile-fixed collaborative guidance according to claim 8, wherein the performing global path planning through a dual-mode adaptive confined space disease detection path planning algorithm to generate a precise detection path and a supplementary detection path in the S2 comprises:
S21, acquiring a basic disease data map and a three-dimensional map model of the confined space;
S22, dividing the confined space into a plurality of sections according to the basic disease data map and the three-dimensional map model of the confined space, and determining characteristics of each of the sections according to fixed sensor distribution and known disease distribution;
S23, determining a task type for the each section according to the characteristics of the each section;
S24, performing detection planning on the each section according to the task type of the each section, to obtain a precise detection plan and a supplementary detection plan;
S25, generating a precise detection path and a supplementary detection path according to the precise detection plan and the supplementary detection plan; and
S26, optimizing the precise detection path by using an obstacle avoidance algorithm to obtain an optimized precise detection path, and optimizing the supplementary detection path by using the obstacle avoidance algorithm to obtain an optimized supplementary detection path.

13. The structure detection system for a low-light confined space based on mobile-fixed collaborative guidance according to claim 8, after the UAV detection system detecting the diseases in the low-light confined space according to the precise detection path and the supplementary detection path through the U-Net deep learning algorithm to obtain the disease map result of the structure of the low-light confined space in the S3, further comprising:
the mobile-fixed collaborative system adopting an information decentralization method to send a notification message to a specified fixed sensor node, and the specified fixed sensor node receiving the notification message and shortening a perception period of the mobile-fixed collaborative system by adjusting a perception period of the fixed sensor, to obtain a new perception period of the mobile-fixed collaborative system.

14. The structure detection system for a low-light confined space based on mobile-fixed collaborative guidance according to claim 13, wherein the mobile-fixed collaborative system adopting the information decentralization method to send the notification message to the specified fixed sensor node and the specified fixed sensor node receiving the notification message and shortening the perception period of the mobile-fixed collaborative system by adjusting the perception period of the fixed sensor to obtain the new perception period of the mobile-fixed collaborative system comprises:
the mobile-fixed collaborative system determining an impact range of each of detected diseases according to the disease map result of the structure of the low-light confined space detected by the UAV detection system;
determining a notified fixed sensor set according to the impact range of the each detected disease;
constructing a communication function according to the notified fixed sensor set, and constructing a perception period adjustment function according to the communication function;
performing perception period adjustment on each of the fixed sensors according to the perception period adjustment function, and outputting the adjusted perception period of the each fixed sensor; and
shortening the perception period of the mobile-fixed collaborative system according to the adjusted perception period of the each fixed sensor, to obtain the new perception period of the mobile-fixed collaborative system.

15. The structure detection system for a low-light confined space based on mobile-fixed collaborative guidance according to claim 8, wherein the mobile-fixed collaborative system updates a fixed sensor node network deployment plan according to the results of diseases not covered by the fixed sensors to obtain a new fixed sensor node network deployment plan, the updating comprising:
constructing a fixed sensor deployment utility function according to the results of diseases not covered by the fixed sensors;
defining a fixed sensor coverage function, and constructing an optimization problem based on the fixed sensor coverage function; and
solving the optimization problem by using a Monte Carlo tree search algorithm to obtain the new fixed sensor node network deployment scheme.

16. The structure detection system for a low-light confined space based on mobile-fixed collaborative guidance according to claim 15, after the obtaining the new fixed sensor node network deployment plan, further comprising:
constructing a deployment decision function, and evaluating the new fixed sensor node network deployment plan according to the deployment decision function to obtain an evaluation result; and
determining, according to the evaluation result, whether to execute the new fixed sensor node network deployment plan based on the evaluation result, wherein if the evaluation result is 1, the new fixed sensor node network deployment plan is executed to update a fixed sensor network topology, and if the evaluation result is 0, an original fixed sensor node network deployment plan is kept.
